(19) United States
(12) Patent Application Publication
(10) Pub. No.: US 2023/0340653 A1
(43) Pub. Date: Oct. 26, 2023

(54) METHOD OF MANUFACTURING AIRCRAFT MEMBER

(71) Applicants: MITSUBISHI HEAVY INDUSTRIES, LTD., TOKYO (JP); NATIONAL UNIVERSITY CORPORATION KUMAMOTO UNIVERSITY, Kumamoto-shi, Kumamoto (JP)

(72) Inventors: Takayuki TAKAHASHI, Tokyo (JP); Hiroki MORI, Tokyo (JP); Yoshihito KAWAMURA, Kumamoto-shi, Kumamoto (JP); Michiaki YAMASAKI, Kumamoto-shi, Kumamoto (JP)

(21) Appl. No.: 17/766,423

(22) PCT Filed: Oct. 8, 2020
(86) PCT No.: PCT/JP2020/038122

§ 371 Date: Apr. 4, 2022

(30) Foreign Application Priority Data
Oct. 11, 2019 (JP) 2019-187678

(51) Int. Cl. C22F 1/06; C22C 23/02

(52) U.S. Cl. CPC C22F 1/06; C22C 23/02

(57) ABSTRACT

The present disclosure intends to provide an aircraft member having both high strength and good ductility. Further, the present disclosure intends to provide an aircraft member satisfying required flame resistance. Further, the present disclosure intends to provide an aircraft member satisfying required corrosion resistance. In a method of manufacturing the aircraft member according to the present disclosure, a billet of an Mg—Al—Ca based alloy is extruded at an extrusion temperature that is higher than or equal to 350° C. and lower than or equal to 400° C. and at a ram rate that is higher than or equal to 1 mm/sec and lower than or equal to 3 mm/sec.

### TECHNICAL FIELD

The present disclosure relates to a method of manufacturing an aircraft member, in particular, a method of manufacturing a secondary structure member of an aircraft.

### BACKGROUND ART

There is an increasing need for reduction in aircraft weight of civil aircrafts due to the recent demand for higher fuel efficiency. While aluminum alloys have been used for main structure members (fuselage outer panels or the like) of conventional civil aircrafts, increase of the strength of aluminum alloy members has reached its limit, and a material with higher specific strength is currently required to be applied.

In such a circumstance, composite materials have been applied to the main structure of aircraft in recent years; however, there currently are problems of high manufacturing cost, long manufacturing lead time, high assembly cost, and the like.

To solve such problems, a magnesium alloy has been studied. The magnesium alloy is manufactured at substantially the same cost as aluminum alloys and has substantially the same or greater specific strength (see Patent Literatures 1 and 2).

Magnesium alloys are active metals and thus require anticorrosion treatment. In Patent Literature 1, a non-chromate conversion coating is formed on the surface of a magnesium alloy to improve corrosion resistance. In Patent literature 2, the number and the size of fine precipitates containing both Mg and Al present on the surface region are defined to obtain a magnesium alloy member having high corrosion resistance requiring no anticorrosion treatment.

### CITATION LIST

### Patent Literature

### [PTL 1]

Japanese Patent Application Laid-Open No. 2008-536013

### [PTL 2]

Japanese Patent Application Laid-Open No. 2010-209452

### SUMMARY OF INVENTION

### Technical Problem

In addition to high corrosion resistance, materials applied to aircraft members are required to have both high strength (tensile resistance) and good ductility (elongation). Magnesium alloys have lower strength than aluminum alloys. Thus, the strength of magnesium alloys needs to be improved; however, the strength of magnesium alloys has a trade-off relationship with ductility, and it has been difficult to achieve both high strength and good ductility.

Further, to apply a magnesium alloy to an aircraft member, it is required to improve flame resistance to increase the ignition temperature.

The present disclosure has been made in view of such circumstances, and an object of the present disclosure is to provide an aircraft member having both high strength and good ductility. Further, another object of the present disclosure is to provide an aircraft member satisfying required flame resistance. Further, yet another object of the present disclosure is to provide an aircraft member satisfying required corrosion resistance.

### Solution to Problem

To achieve the objects described above, a method of manufacturing an aircraft member of the present disclosure employs the following solutions.

The present disclosure provides a method of manufacturing an aircraft member, and the method includes a step of extruding a billet of an Mg—Al—Ca based alloy at an extrusion temperature that is higher than or equal to 350° C. and lower than or equal to 400° C. and at a ram rate that is higher than or equal to 1 mm/sec and lower than or equal to 3 mm/sec.

In Mg—Al—Ca based alloys, the crystal particle diameter and the microstructure vary depending on extrusion conditions, and this changes the strength and the ductility. In the present disclosure, an Mg—Al—Ca based alloy is processed with the extrusion conditions described above, and this can obtain an aircraft member (extruded material) having tensile resistance of 280 MPa or higher and elongation of 3.0% or larger.

In one aspect of the disclosure described above, the Mg—Al—Ca based alloy has a composition containing a atomic % of Ca, containing b atomic % of Al, containing k atomic % of Mn, and having the remaining part consisting of Mg and contains c volume % of (Mg, Al)₂Ca, and a, b, c, and k satisfy the following equations (1) to (4) and (21):
(1) 3≤a≤7,
(2) 4.5≤b≤12 (preferably, 8≤b≤12),
(3) 1.2≤b/a≤3.0,
(4) 10≤c≤35 (preferably, 10≤c≤30), and
(21) 0<k≤0.3 (preferably, 0.01≤k≤0.05), and
(Mg, Al)₂Ca is dispersed.

Addition of Ca can improve the flame resistance and the mechanical characteristics of the extruded material. If the Ca content exceeds 7 atomic %, this makes it difficult to have a solidified state of the magnesium alloy and makes extrusion processing difficult. If the Ca content is less than 3 atomic %, this makes it impossible to obtain sufficient flame resistance. By containing Ca of 3 atomic % or more in Mg, it is possible to increase the ignition temperature of the extruded material to 900° C. or higher.

Addition of Al can improve the mechanical characteristics and the corrosion resistance of the extruded material. If the Al content exceeds 12 atomic %, this makes it impossible to obtain sufficient strength. If the Al content is less than 4.5 atomic %, this makes it impossible to obtain sufficient ductility.

(Mg, Al)₂Ca is dispersed in the metallic structure, and this can obtain high strength and relatively large ductility.

Addition of Mn can further raise the ignition temperature of the extruded material. Addition of Mn can improve the corrosion resistance of the extruded material. According to results of intensive study made by the present inventors, it has been found that an excessive amount of addition of Mn deteriorates the internal quality. An addition amount of Mn within the range described above can improve corrosion resistance without deteriorating the internal quality.

The Mg—Al—Ca based alloy described above has a smaller specific gravity than aluminum alloys used in the conventional aircraft field. Thus, by processing such an Mg—Al—Ca based alloy to form an aircraft member, it is possible to reduce the weight by 10% or more compared to aluminum alloy members.

For “the remaining part consisting of Mg”, this not only means a case where the whole remaining part consists of Mg but also means a case where the remaining part contains an impurity or another element to the extent that does not affect the alloy characteristics.

In one aspect of the disclosure described above, it is desirable to, before the extruding step, perform thermal treatment on the billet at a temperature that is higher than or equal to 400° C. and lower than or equal to 500° C. for a period that is longer than or equal to 1 hour and shorter than or equal to 6 hours. It is more desirable that the thermal treatment time be a short time around one hour.

By performing thermal treatment on a billet with the conditions described above before the extruding step, it is possible to improve the ductility of the extruded material while ensuring desired strength (tensile resistance). The same advantageous effect is not expected with thermal treatment applied after extrusion.

In one aspect of the disclosure described above, the Mg—Al—Ca based alloy may contain Si of 0.05 atomic % or more and 0.3 atomic % or less.

Addition of Si can improve ductility of the extruded material. If the Si content is less than 0.05 atomic %, this is less effective in improving ductility. If the Si content exceeds 0.3 atomic %, this makes it difficult to ensure uniformity of components, and the elongation rather decreases.

### Advantageous Effects of Invention

According to the manufacturing method of the present disclosure, the conditions of the extrusion temperature and the ram rate are optimized, and this can obtain an aircraft member having both high strength and good ductility. According to the manufacturing method of the present disclosure, an aircraft member satisfying required flame resistance can be obtained. According to the manufacturing method of the present disclosure, an aircraft member satisfying required corrosion resistance can be obtained.

### BRIEF DESCRIPTION OF DRAWINGS

FIG. 1 is a diagram illustrating a relationship between extrusion temperatures and tensile resistance.

FIG. 2 is a diagram illustrating a relationship between extrusion temperatures and elongation.

FIG. 3 is a diagram illustrating a relationship between ram rates and tensile resistance.

FIG. 4 is a diagram illustrating a relationship between ram rates and elongation.

FIG. 5 is a diagram illustrating changes in elongation and tensile resistance due to thermal treatment.

FIG. 6 is a diagram illustrating a result of a corrosion test.

FIG. 7 is a diagram illustrating a result of an ignition test.

### DESCRIPTION OF EMBODIMENTS

A manufacturing method according to the present disclosure is suitable for manufacturing of a secondary structure member used for an aircraft. The secondary structure member is a member attached to a primary structure member such as a stringer. The secondary structure member may be a clip, a bracket, a metal fitting to fasten pipes, a seat frame, and the like. The secondary structure member is a member less subjected to a large load than the primary structure member.

One embodiment of the method of manufacturing an aircraft member according to the present disclosure will be described below with reference to the drawings.

In the present embodiment, an aircraft member is manufactured by extruding an Mg—Al—Ca based alloy billet at an extrusion temperature that is higher than or equal to 350° C. and lower than or equal to 450° C. (preferably, higher than or equal to 375° C. and lower than or equal to 400° C.) and at a ram rate that is higher than or equal to 1 mm/sec and lower than or equal to 3 mm/sec.

The extrusion ratio may be greater than or equal to 10 and less than or equal to 80.

The cross section of an extruded material after extrusion may be, for example, an L-shape, a T-shape, or a Z-shape.

The diameter of a billet is greater than or equal to 29 mm and less than or equal to 180 mm, preferably greater than or equal to 29 mm and less than or equal to 69 mm. The billet having the diameter described above is suitable for manufacturing of an extruded material having an L-shape cross section, an extruded material having a Z-shape cross section, and the like. For manufacturing of a large raw material, use of a billet having a somewhat large diameter is desirable. However, an excessively large billet diameter may cause a problem of coarse inclusions such as an Mg—Al—Ca based compound, an Mg—Si—Ca based compound, and the like due to a cooling rate during billet manufacturing, and this makes it difficult to achieve both good ductility and high tensile strength. With a billet having a diameter within the range described above, it is possible to achieve both good ductility and high tensile strength.

It is desirable that, before extrusion processing, a billet of an Mg—Al—Ca based alloy be subjected to thermal treatment at a temperature that is higher than or equal to 400° C. and lower than or equal to 500° C. for a period that is longer than or equal to 1 hour and shorter than or equal to 6 hours. The treatment temperature is preferably higher than or equal to 450° C. and lower than or equal to 500° C. It is more desirable that the treatment time be a short time around one hour.

The Mg—Al—Ca based alloy has a composition containing “a” atomic % of Ca, containing “b” atomic % of Al, containing “k” atomic % of Mn, and having the remaining part consisting of Mg and contains “c” volume % of (Mg, Al)₂Ca, and “a”, “b”, “c”, and “k” satisfy the following equations (1) to (4) and (21). The (Mg, Al)₂Ca is dispersed. Mn is an element that improves at least one of corrosion resistance and flame resistance.
(1) 3≤a≤7,
(2) 4.5≤b≤12 (preferably, 8≤b≤12)
(3) 1.2≤b/a≤3.0,
(4) 10≤c≤35 (preferably, 10≤c≤30)
(21) 0<k≤0.3 (preferably, 0.01≤k≤0.05)

While addition of even a small amount of Mn has an advantageous effect of improving corrosion resistance, an increase in the amount of addition involves a reduction of ductility. To achieve both high corrosion resistance and good ductility, it is desirable to keep the addition amount of Mn low.

The Mg—Al—Ca based alloy may contain “x” atomic % of Si.
(22) 0.05≤x≤0.3 (preferably, 0.05≤x≤0.1)

Inclusion of Si within the range described above can improve ductility. When the ductility has decreased due to addition of Mn, the ductility can be improved by addition of Si.

The extrusion processing condition and the thermal treatment condition are set based on the grounds described below.

### [Extrusion Temperature]

Billets 1 and 2 were extruded with predetermined conditions, to obtain extruded materials 1 and 2. A tensile test was performed on the extruded materials 1 and 2 at room temperature to evaluate the mechanical characteristics.
Billet 1: Mg-10Al-5Ca-0.05Mn (ϕ69 mm)
Billet 2: Mg-10Al-5Ca-0.05Mn-0.1Si (ϕ69 mm)
Extrusion temperature (° C.): 250, 350, 400, 425
Extrusion ratio: 15, 22
Ram rate (mm/sec): 1, 3

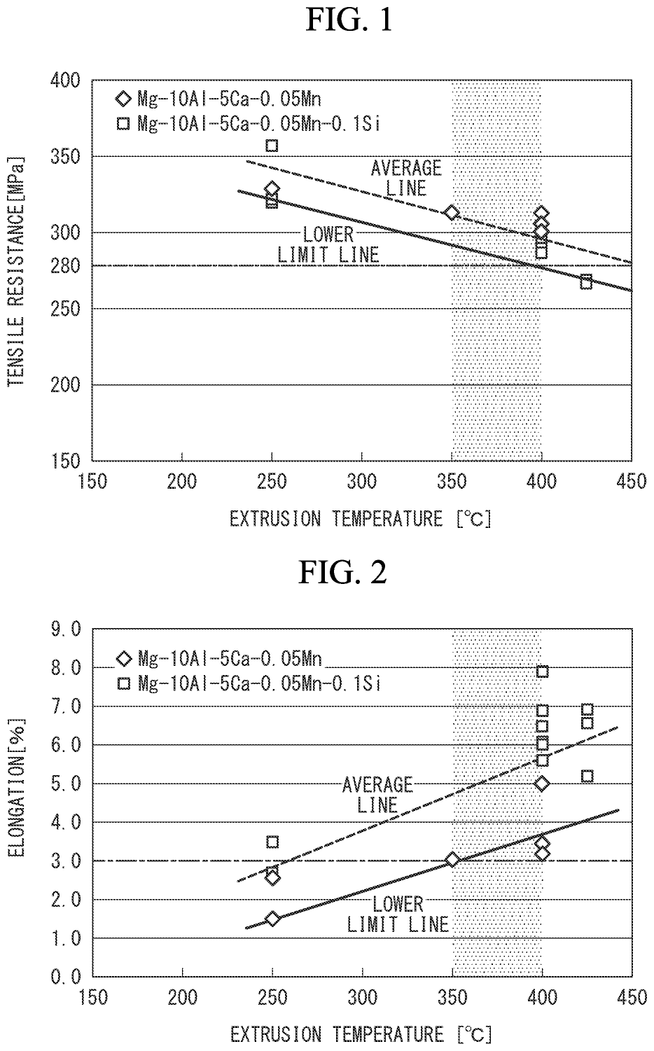

FIG. 1 and FIG. 2 illustrate results of the tensile test. In FIG. 1, the horizontal axis represents the extrusion temperature (° C.), the vertical axis represents the tensile resistance (MPa), the solid line is a lower limit line of variation, and the dashed line is an average line of variation. In FIG. 2, the horizontal axis represents the extrusion temperature (° C.), the vertical axis represents the elongation (%), the solid line is a lower limit line of variation, and the dashed line is an average line of variation. The lower limit line and the average line of variation are extrapolated from the total plots of the extruded materials 1 and 2 at respective extrusion temperatures.

FIG. 1 indicates that, as the extrusion temperature increases, the tensile resistance decreases. To manufacture an aircraft member that is lighter by 10% or more than the currently used aluminum member, it is desirable that the tensile resistance be 280 MPa or higher. When the extrusion temperature is lower than or equal to 400° C., a member having tensile resistance exceeding about 280 MPa can be obtained.

FIG. 2 indicates that, as the extrusion temperature increases, the elongation improves. For application to an aircraft member, it is required to achieve both high strength and good elongation, and it is desirable that the elongation be larger than or equal to 3.0%. When the extrusion temperature is higher than or equal to 350%, the elongation will be larger than or equal to 3.0% on the lower limit line of variation. It was observed that, with an extrusion temperature of 400° C., elongation of about 5% to 7% in average is obtained.

In comparison between the extruded material 2 and the extruded material 1, it was observed that the extruded material 2 extruded from the billet 2 containing Si tends to have a higher elongation rate. FIG. 2 indicates that, when the billet 2 is extruded at 350° C. or higher, an extruded material has elongation of 4.0% or larger.

### [Ram Rate]

The billets 1 and 2 are extruded with predetermined conditions, to obtain extruded materials 3 and 4. A tensile test was performed on the extruded materials 3 and 4 at room temperature to evaluate the mechanical characteristics.
Billet 1: Mg-10Al-5Ca-0.05Mn (ϕ69 mm)
Billet 2: Mg-10Al-5Ca-0.05Mn-0.1Si (ϕ69 mm)
Extrusion temperature (° C.): 400
Extrusion ratio: 15, 22
Ram rate (mm/sec): 1, 2, 3, 4, 5, 7

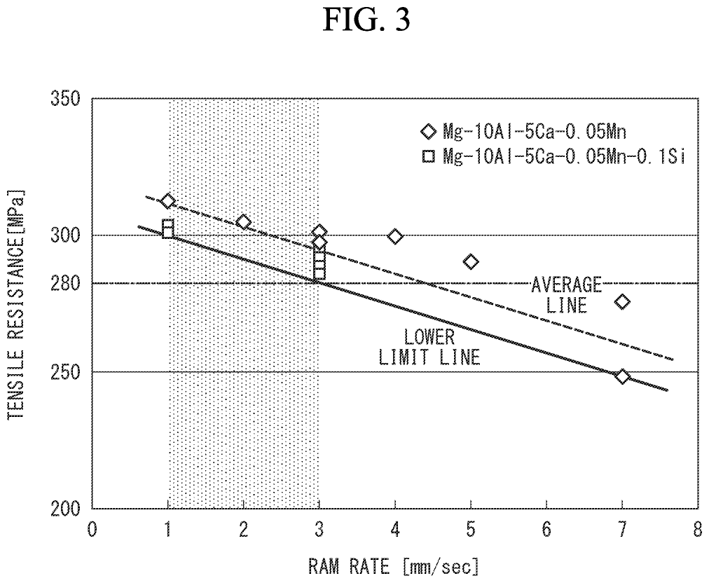

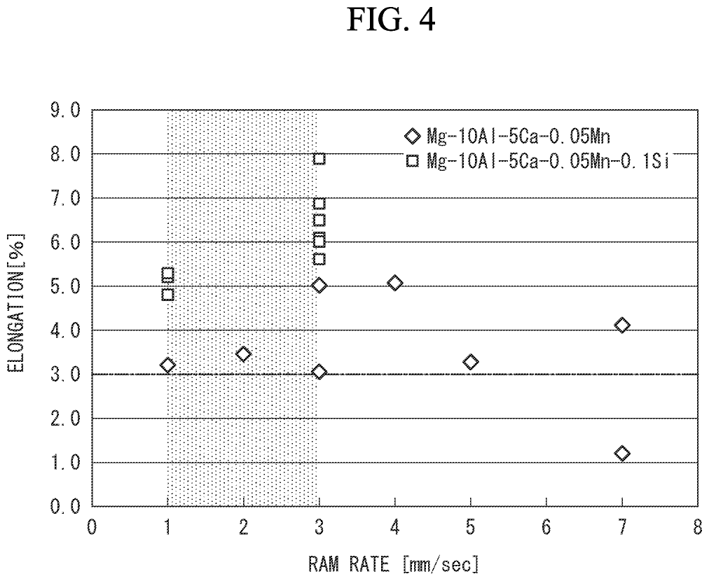

FIG. 3 and FIG. 4 illustrate results of the tensile test. In FIG. 3, the horizontal axis represents the ram rate (mm/sec), the vertical axis represents the tensile resistance (MPa), the solid line is a lower limit line of variation, and the dashed line is an average line of variation. The lower limit line and the average line of variation are extrapolated from the total plots of the extruded materials 3 and 4 at respective extrusion temperatures. In FIG. 4, the horizontal axis represents the ram rate (mm/sec), and the vertical axis represents the elongation (%).

FIG. 3 indicates that, as the ram rate increases, the tensile resistance decreases. This may be because an increased ram rate causes the extruded material to be heated due to friction resistance (deformation resistance) during extrusion resulting in reduced strength. FIG. 3 indicates that, when the ram rate is lower than or equal to 3 mm/sec, the lower limit line of variation is higher than or equal to 280 MPa, and the requirement is satisfied. Since an excessively low ram rate reduces productivity, it is preferable that the lower limit be 1 mm/sec or higher.

FIG. 4 indicates that the elongation had no clear tendency with respect to the ram rate. It was observed that the elongation is larger than or equal to 3.0 when the ram rate ranges from 1 mm/sec or higher to 3 mm/sec or lower.

The variation among plots from FIG. 1 to FIG. 4 is due to a difference in quality of the billets. FIG. 1 to FIG. 4 indicate that, even with variation in quality or the like due to a difference in production lots, extrusion processing at an extrusion temperature of 350° C. or higher and 400° C. or lower and at a ram rate of 1 mm/sec or higher and 3 mm/sec or lower can obtain an extruded material having tensile strength of 280 MPa or higher and elongation (ductility) of 3.0% or larger.

[Thermal Treatment before Extrusion]

The billet 3 was subjected to thermal treatment and then extruded with a predetermined condition to obtain an extruded material 5. A tensile test was performed on the extruded material 5 at room temperature to evaluate the mechanical characteristics.
Billet 3: Mg-10Al-5Ca-0.05Mn-0.1Si (ϕ69 mm)
Thermal treatment condition: 450° C. for 1H, 450° C. for 6H, 500° C. for 1H
Extrusion temperature (° C.): 400
Extrusion ratio: 15
Ram rate (mm/sec): 1

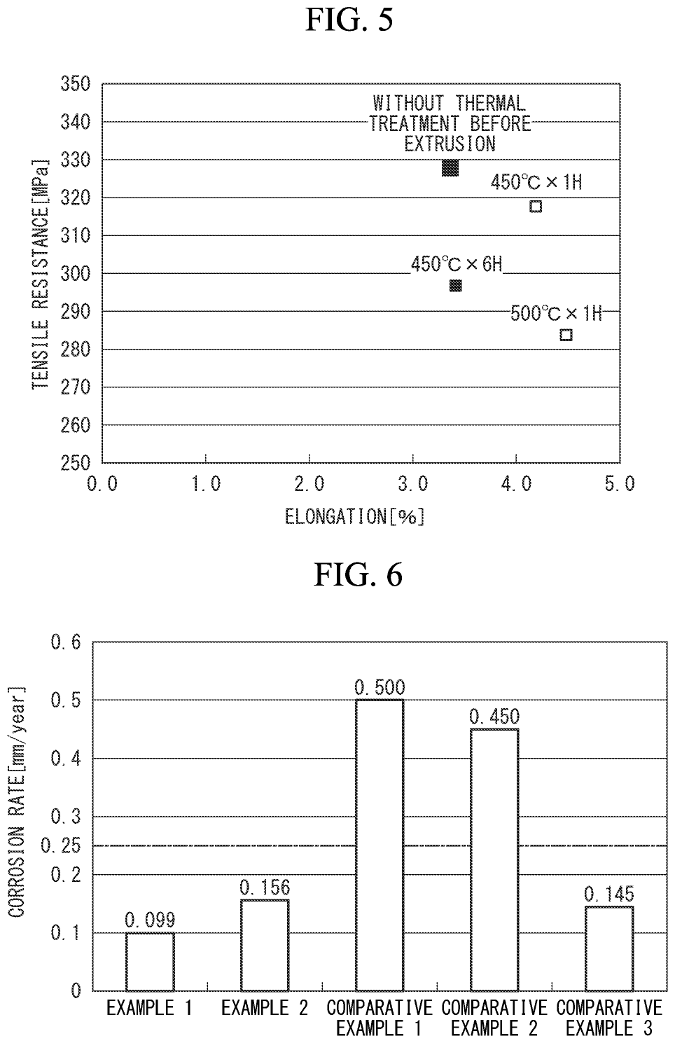

FIG. 5 illustrates a result of the tensile test. In FIG. 5, the horizontal axis represents the elongation (%), and the vertical axis represents the tensile resistance (MPa). It was observed from FIG. 5 that it is possible to improve the elongation of the extruded material by applying thermal treatment before extrusion processing.

When the treatment time is the same, treatment at a higher temperature improves the elongation. On the other hand, when treatment is performed at the same temperature, a shorter treatment time improves the elongation. The reason why a longer treatment time reduces the elongation may be due to influence of inclusions in the Mg—Al—Ca based alloy. This result revealed that, in the Mg—Al—Ca based alloy in which inclusions are present, a mere increase in heat input does not improve the elongation, but the elongation is improved with the optimal treatment temperature and treatment time. Herein, “inclusion” may be an Mg—Al—Ca based compound, an Mg—Si—Ca based compound, or the like.

FIG. 5 indicates that the extruded material 5 extruded from the billet 3, which was subjected to thermal treatment at 400° C. to 500° C. for 1 hour to 6 hours, had tensile resistance of 280 MPa or higher and elongation of 3.0% or larger. FIG. 5 indicates that, when the thermal treatment temperature is 400° C., improvement in elongation can be expected with the treatment over 1 hour to 3 hours. When the thermal treatment temperature is 450° C., improvement in elongation can be expected with the treatment over 1 hour to 6 hours. When the thermal treatment temperature is 500° C., improvement in elongation can be expected with the treatment over 1 hour. All the extruded materials extruded from a billet, which were subjected to the thermal treatment with the conditions described above, satisfy the requirement of tensile resistance of 280 MPa or higher.

### [Corrosiveness]

Corrosion tests were performed on extruded materials of Examples 1 and 2 and Comparative examples 1 to 3 (test plate, n=3) with a method in accordance with ATSM B117. More specifically, rectangular test plates were leaned against the interior of a chamber, salt water (5% NaCl) was continuously sprayed for 96 hours, a change in weight between the test plate before spraying and the test plate after spraying was measured, and a reduction in thickness (corrosion rate) was calculated.

### Example 1

Used billet: Mg-10Al-5Ca-0.05Mn-0.1Si (ϕ69 mm)
Extrusion temperature (° C.): 400
Extrusion ratio: 15
Ram rate (mm/sec): 3

### Example 2

Example 2 was manufactured on a different day from Example 1.
Used billet: Mg-10Al-5Ca-0.05Mn-0.1Si (ϕ69 mm)
Extrusion temperature (° C.): 400
Extrusion ratio: 22
Ram rate (mm/sec): 1

### Comparative Example 1

Used billet: rapidly solidified magnesium alloy (Mg—Zn—Y—Al based, ϕ69 mm)

### Comparative Example 2

Used billet: commercially available magnesium alloy (Elektron 43, ϕ69 mm)

### Comparative Example 3

Used billet: commercially available aluminum alloy (7075-T6, ϕ69 mm)

While Comparative example 1 uses the same type of billet as Examples 1 and 2, the extrusion processing conditions are different. The billet of Comparative example 2 is a commercially available magnesium alloy and significantly differs in tensile resistance from the alloys of Examples 1 and 2.

FIG. 6 illustrates the result. In FIG. 6, the vertical axis represents the corrosion rate (mm/year), and a bar for each test piece represents an average value. FIG. 6 indicates that the corrosion rates (averages) of Examples 1 and 2 are 0.099 mm/year and 0.156 mm/year, respectively. On the other hand, the corrosion rates of Comparative examples 1 and 2 are 0.500 mm/year and 0.450 mm/year, respectively. The corrosion rate of Comparative example 3 is 0.145 mm/year.

Examples 1 and 2 manufactured in accordance with the present embodiment exhibited reduced corrosion rates compared to Comparative examples 1 and 2. From this result, it was confirmed that a difference in extrusion conditions affects the corrosion rate even with the same type of Mg—Al—Ca based alloys. The corrosion rates of Examples 1 and 2 are substantially the same as that of the aluminum alloy (Comparative example 3) used for the conventional aircraft member.

### [Flame Resistance]

Extruded materials (test piece) of Example 3 and Comparative examples 4 and 5 were heated by a heater to observe the temperature at the time of ignition.

### Example 3

Used billet: Mg-10Al-5Ca-0.05Mn-0.1Si (ϕ69 mm)
Extrusion temperature (° C.): 400
Extrusion ratio: 22
Ram rate (mm/sec): 3

### Comparative Example 4

Used billet: commercially available magnesium alloy (Elektron 43, ϕ69 mm)

### Comparative Example 5

Used billet: commercially available magnesium alloy (Elektron 675, ϕ69 mm)

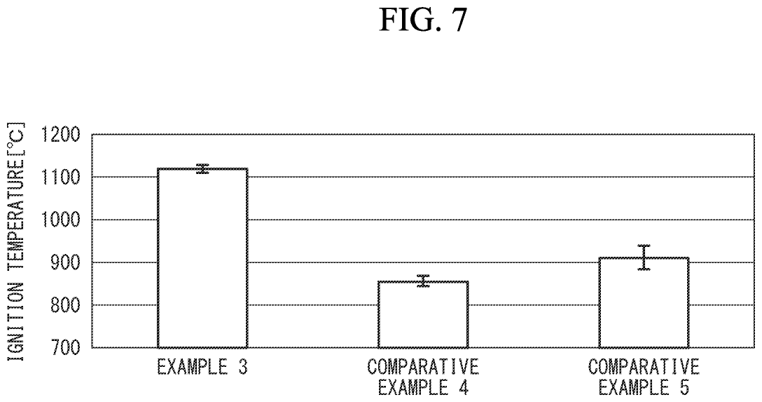

FIG. 7 illustrates the result. In FIG. 7, the vertical axis represents the ignition temperature (° C.). The ignition temperature of Example 3 exceeded 1100° C. On the other hand, the ignition temperatures of Comparative examples 4 and 5 were 850° C. and 910° C., respectively. From this result, according to the present embodiment, it was proven that a member superior in flame resistance can be manufactured.

1. A method of manufacturing an aircraft member, the method comprising a step of:
extruding a billet of an Mg—Al—Ca based alloy at an extrusion temperature that is higher than or equal to 350° C. and lower than or equal to 400° C. and at a ram rate that is higher than or equal to 1 mm/sec and lower than or equal to 3 mm/sec.

2. The method of manufacturing the aircraft member according to claim 1, wherein
the Mg—Al—Ca based alloy has a composition containing a atomic % of Ca, containing b atomic % of Al, containing k atomic % of Mn, and having the remaining part consisting of Mg and contains c volume % of (Mg, Al)₂Ca, and a, b, c, and k satisfy the following equations (1) to (4) and (21):
(1) 3≤a≤7,
(2) 4.5≤b≤12,
(3) 1.2≤b/a≤3.0,
(4) 10≤c≤35, and
(21) 0<k≤0.3, and
(Mg, Al)₂Ca is dispersed.

3. The method of manufacturing the aircraft member according to claim 1 further comprising a step of:
before the extruding step, performing thermal treatment on the billet at a temperature that is higher than or equal to 400° C. and lower than or equal to 500° C. for a period that is longer than or equal to 1 hour and shorter than or equal to 6 hours.

4. The method of manufacturing the aircraft member according to claim 1, wherein the Mg—Al—Ca based alloy contains Si of 0.05 atomic % or more and 0.3 atomic % or less.
